(19) United States
(12) Patent Application Publication
(10) Pub. No.: US 2020/0063494 A1
(43) Pub. Date: Feb. 27, 2020

(54) LADDER LEVELER

(71) Applicant: Derryll Mark Brudzinski, Biddeford, ME (US)

(72) Inventor: Derryll Mark Brudzinski, Biddeford, ME (US)

(21) Appl. No.: 16/352,368

(22) Filed: Mar. 13, 2019

Related U.S. Application Data
(60) Provisional application No. 62/720,320, filed on Aug. 21, 2018.

(51) Int. Cl. E06C 7/44

(52) U.S. Cl. CPC E06C 7/44

(57) ABSTRACT

A ladder leveler is provided comprising a first assembly including a first support having a first longitudinal recess, a first leveling member in threaded engagement with the first longitudinal recess, a first connection member extending substantially perpendicular to the first support, and a second connection member extending substantially perpendicular to the first support; and a second assembly including a second support having a second longitudinal recess formed therein, a second leveling member in threaded engagement with the second longitudinal recess, a first insertion member extending substantially perpendicular to the second support and configured for threaded engagement with the first connection member, and a second insertion member extending substantially perpendicular to the second support, the second insertion member configured for threaded engagement with the second connection member, wherein the connection members and the insertion members are sized for extension through and threaded engagement within ladder rungs of a ladder.

### FIELD OF THE INVENTION

This invention relates to ladder equipment and more particularly to a ladder leveler.

### BACKGROUND OF THE INVENTION

Conventionally, ladders include vertically oriented rails connected by a plurality of rungs. The rails are of substantially equal, fixed length and positioned in parallel such that, on flat ground, a first terminal end of each rail includes a stabilizing “foot” which rests on the ground while a second terminal end of each rail rests at an elevated position on a vertical surface, thus providing a stable base on which the user can climb. However, because the rails are of fixed length, positioning the ladder on an inclined or otherwise uneven ground surface can result in dangerous instability and/or be impracticable. This presents a significant obstacle for users such as professional painters who commonly need to paint, for example, the exterior side of a house built on a hill.

Some users attempt to resolve uneven ground instabilities by placing an object such as a rock or lumber under one of the rails. However, such approaches can be dangerous if the object becomes be unstable and slides down the hill, or falls over when subjected to the combined weight of the ladder and the user.

Existing devices for permitting ladder usage on inclined or uneven surfaces require complex installation, including removal of the stabilizing “feet” of the ladder and drilling through the rails of the ladder to bolt or screw on attachment pieces, thus damaging and weakening the ladder. Furthermore, such devices operate by providing a pair of extendable arms, which are each configured to be extended to only a limited number of preset extension positions at which the arms are held in place by a relatively weak pin.

### SUMMARY OF INVENTION

It is an object of the invention to provide a continuously adjustable ladder leveler that can be quickly and removably assembled without damaging the ladder to which it is attached. Other benefits and advantages of the present invention over existing systems will be readily apparent from the Brief Summary of the Invention and Detailed Description to follow. One skilled in the art will appreciate that the present teachings can be practiced with embodiments other than those summarized or disclosed below.

In one aspect, the invention includes a ladder leveler. The ladder leveler includes a first assembly. The first assembly includes a first support having a first longitudinal recess formed therein. The first assembly also includes a first leveling member in threaded engagement with the first longitudinal recess for extension and retraction relative to the first support. The first assembly also includes first connection member extending substantially perpendicular to the first support. The first assembly also includes second connection member extending substantially perpendicular to the first support and substantially parallel to the first connection member. The ladder leveler also includes second assembly. The second assembly includes a second support having a second longitudinal recess formed therein. The second assembly also includes a second leveling member in threaded engagement with the second longitudinal recess for extension and retraction relative to the second support. The second assembly also includes a first insertion member extending substantially perpendicular to the second support and configured for threaded engagement with the first connection member. The second assembly also includes a second insertion member extending substantially perpendicular to the second support and substantially parallel to the first insertion member, the second insertion member configured for threaded engagement with the second connection member. The connection members and the insertion members are sized for extension through and threaded engagement within ladder rungs of a ladder.

In some embodiments, the first support includes two or more first telescoping members. In some embodiments, the second support including two or more second telescoping members. In some embodiments, the first and second connection members extend from different first telescoping members to permit adjustment of spacing therebetween for alignment of the first and second connection members with the ladder rungs. In some embodiments, the first and second insertion members extend from different second telescoping members to permit adjustment of spacing therebetween for alignment of the first and second insertion members with the ladder rungs. In some embodiments, the ladder leveler also includes a first anchor affixed to each of the first telescoping members of the first support. In some embodiments, the ladder leveler also includes a first tether connecting the first anchors for preventing separation of the first telescoping members. In some embodiments, the ladder leveler also includes a second anchor affixed to each of the second telescoping members of the second support. In some embodiments, the ladder leveler also includes a second tether connecting the second anchors for preventing separation of the second telescoping members. In some embodiments, the ladder leveler also includes a first leveling foot engaged with a terminal end of the first leveling member. In some embodiments, the ladder leveler also includes a second leveling foot engaged with a terminal end of the second leveling member. In some embodiments, the ladder leveler also includes a first guide member extending substantially perpendicular to the second support and configured to receive the first insertion member therethrough. In some embodiments, the ladder leveler also includes a second guide member extending substantially perpendicular to the second support and substantially parallel to the first guide member, the second guide member configured to receive the second insertion member therethrough.

In another aspect, a method is provided for assembling a ladder leveler. The method includes aligning a first connection member of a ladder leveler with a hollow end of a first rung of a ladder. The method also includes aligning a second connection member of the ladder leveler with a hollow end of a second rung of the ladder. The method also includes inserting the first and second connection members into the aligned first and second rungs of the ladder. The method also includes aligning a first insertion member of the ladder leveler with an opposing hollow end of the first rung. The method also includes aligning a second insertion member of the ladder leveler with an opposing hollow end of the second rung. The method also includes inserting the first and second insertion members into the aligned first and second rungs of the ladder. The method also includes engaging the first connection member to the first insertion member and the second connection member to the second connection member to secure the ladder leveler to the ladder.

In some embodiments, the first and second connection members each extend perpendicular to one of two or more telescoping members of a first support of the ladder leveler. In some embodiments, the steps of aligning the first and second connection members also include moving at least one of the telescoping members relative to at least one other of the telescoping members to adjust a spacing between the first and second connection members for alignment of the first and second connection members with the hollow ends of the first and second rungs. In some embodiments, the first support also includes an anchor affixed to each of the telescoping members of the first support. In some embodiments, the first support also includes a tether connecting the anchors for preventing separation of the telescoping members. In some embodiments, the first and second insertion members each extend perpendicular to one of two or more telescoping members of a second support of the ladder leveler. In some embodiments, the steps of aligning the first and second insertion members also include moving at least one of the telescoping members relative to at least one other of the telescoping members to adjust a spacing between the first and second insertion members for alignment of the first and second insertion members with the opposing hollow ends of the first and second rungs. In some embodiments, the second support also includes an anchor affixed to each of the telescoping members of the second support. In some embodiments, the second support also includes a tether connecting the anchors for preventing separation of the telescoping members.

In still another aspect, a method for using a ladder leveler is provided. The method includes providing a ladder leveler assembled to a ladder. The ladder leveler includes a first assembly. The first assembly includes a first support having a first longitudinal recess formed therein. The first assembly also includes a first leveling member in threaded engagement with the first longitudinal recess. The ladder leveler also includes a second assembly. The second assembly includes a second support having a second longitudinal recess formed therein. The second assembly also includes a second leveling member in threaded engagement with the second longitudinal recess. The method also includes threading or unthreading at least one of the first leveling member or the second leveling member such that the first leveling member extends from the first support by a different distance than the second leveling member extends from the second support.

In some embodiments, the method also includes placing a terminal end of the first leveling member on a first portion of a surface, the surface being at least one of uneven, sloped, or stepped. In some embodiments, the method also includes placing a terminal end of the second leveling member on a second portion of the surface, the second portion of the surface having a different height than the first portion of the surface. In some embodiments, placement of the terminal ends of the first and second leveling members on the respective first and second portions of the surface causes each of a plurality of rungs of the ladder to extend substantially horizontally without sloping. In some embodiments, the ladder leveler also includes a first leveling foot engaged with a terminal end of the first leveling member. In some embodiments, the ladder leveler also includes a second leveling foot engaged with a terminal end of the second leveling member. In some embodiments, the method also includes placing the first leveling foot on a first portion of a surface, the surface being at least one of uneven, sloped, or stepped. In some embodiments, the method also includes placing the second leveling foot on a second portion of the surface, the second portion of the surface having a different height than the first portion of the surface. In some embodiments, placement of the first and second leveling feet on the respective first and second portions of the surface causes each of a plurality of rungs of the ladder to extend substantially horizontally without sloping.

### BRIEF DESCRIPTION OF THE FIGURES

Embodiments of the present disclosure will now be described, by way of example only, with reference to the attached Figures, wherein:

FIG. 1A is a front view of a ladder leveler in accordance with various embodiments.

FIG. 1B is a front view of a first side assembly of the ladder leveler of FIG. 1A in accordance with various embodiments.

FIG. 1C is a front view of a second side assembly of the ladder leveler of FIG. 1A in accordance with various embodiments.

FIG. 2 is a top cross-sectional view of the second side assembly of FIG. 1B assembled to a ladder in accordance with various embodiments.

FIG. 3 is a top cross-sectional view of second configuration of the second side assembly assembled to a ladder in accordance with various embodiments.

FIG. 4 is a top cross-sectional view of third configuration of the second side assembly assembled to a ladder in accordance with various embodiments.

FIG. 5A is a cross-sectional front view of the ladder leveler of FIG. 1A assembled to a ladder in a retracted position in accordance with various embodiments.

FIG. 5B is a cross-sectional front view of the ladder leveler of FIG. 1A assembled to a ladder in an extended position in accordance with various embodiments.

FIGS. 6A and 6B are cross-sectional views of rung spacers for positioning over one or more connector pins of the ladder leveler.

FIG. 7 is a cross-sectional view of the second side assembly including the rung spacers of FIG. 5A positioned over the male connector pins of the first side assembly.

### DETAILED DESCRIPTION OF THE INVENTION

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments, as the skilled artisan would recognize, even if not explicitly stated herein.

Descriptions of well-known components and processing techniques may be omitted to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

Generally, positioning ladders on an inclined or otherwise uneven ground surface can result in dangerous instability and/or be impracticable. Some users attempt to resolve uneven ground instabilities by placing an object such as a rock or lumber under one of the rails. However, such approaches can be dangerous if the object becomes be unstable and slides down the hill, or falls over when subjected to the combined weight of the ladder and the user.

Existing devices for permitting ladder usage on inclined or uneven surfaces require complex installation, including removal of the stabilizing “feet” of the ladder and drilling through the rails of the ladder to bolt or screw on attachment pieces, thus damaging and weakening the ladder. Furthermore, such devices operate by providing a pair of extendable arms, which are each configured to be extended to only a limited number of preset extension positions at which the arms are held in place by a relatively weak pin, which generally limits the weight that the modified ladder is rated to withstand.

Provided herein are ladder leveling apparatus and methods therefore. More particularly, in accordance with various embodiments, continuously adjustable ladder levelers are provided herein. In some embodiments, such ladder levelers can be quickly and easily assembled and disassembled to a ladder without damaging the ladder to which it is assembled and disassembled. In particular, such ladder levelers can include first and second independently adjustable leveling members that, when the ladder leveler is assembled to the ladder, can be continuously adjusted to extend a desired distance beyond a bottom foot of the slide rail of the ladder. A differential between the extension distance of the first and second leveling members permits the ladder to achieve stable footing on uneven surfaces or slopes of any angle as needed to position the top of the ladder proximate a target area.

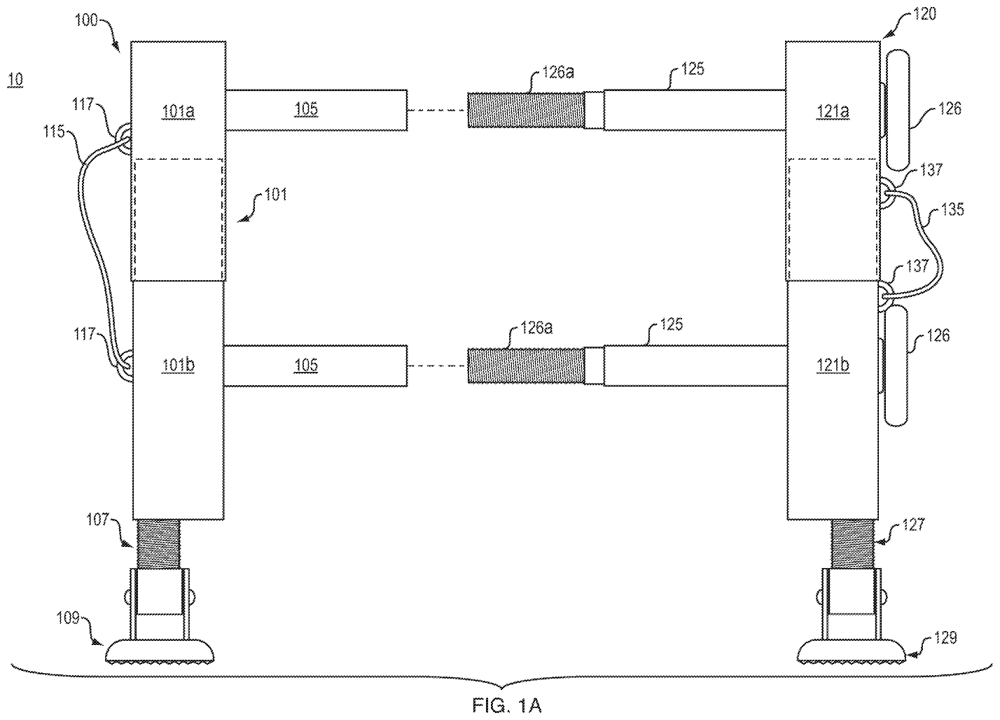

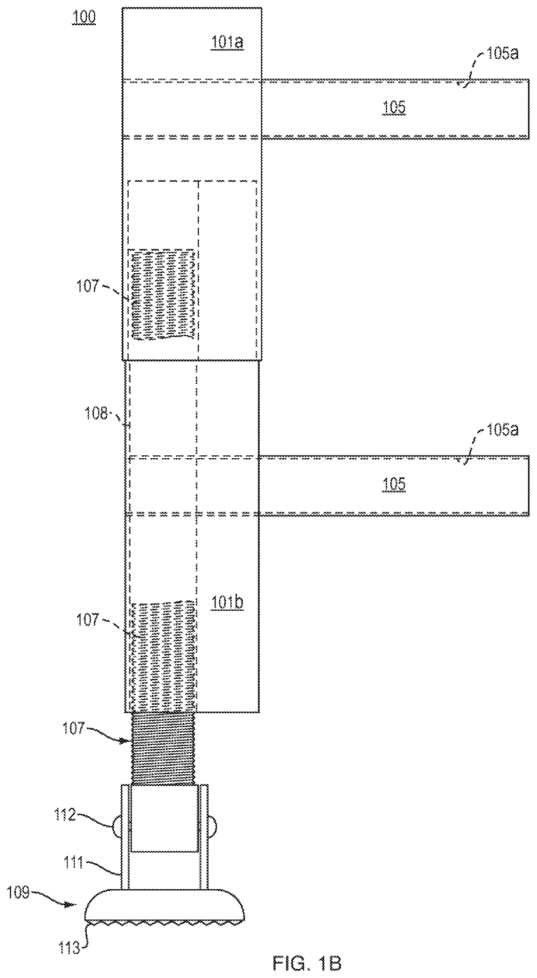

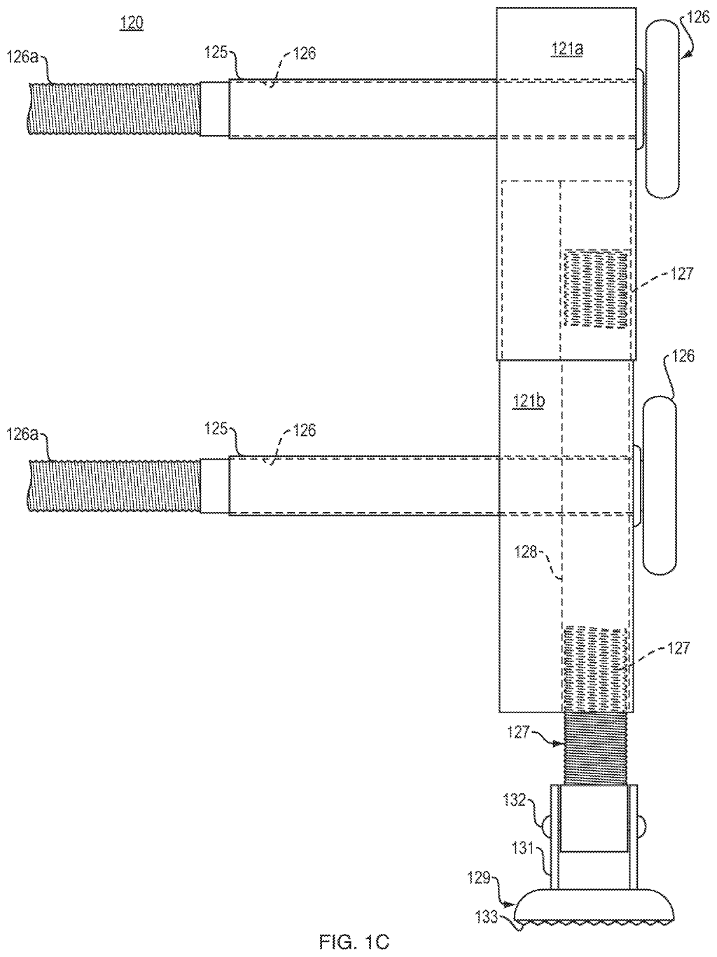

Referring now to FIGS. 1A-1C, a ladder leveler 10 in accordance with various embodiments can include a first assembly 100 and a second assembly 120 configured for assembly to opposing slide rails through one or more rungs of the ladder.

Referring now to FIG. 1B, the first assembly 100 can include a first support 101. As shown in FIG. 1B, in some embodiments, the first support 101 can include a first telescoping member 101a and a second telescoping member 101b for adjustable dimensioning in connection with assembly of the ladder leveler 10 to any size or style of ladder. In particular, provision of the telescoping members 101a, 101b can permit adjustment of a distance between two or more connection members 105 extending from the first support 101 to align the connection members 105 for extension at least partially through respective rungs of the ladder. It will be apparent in view of this disclosure that, although the first support 101 is shown herein as including first and second telescoping members 101a, 101b, in some embodiments, the first support 101 can further include any number of additional telescoping members as desired. In some embodiments, a number of telescoping members of the first support 101 can correspond to a number of connection members 105 extending from the first support 101.

In some embodiments, to avoid inadvertent separation of the telescoping members 101a, 101b, the first assembly 100 can include at least two anchors 117 connected by a tether 115. In some embodiments, one anchor can be installed on each telescoping member (or at least on each of two telescoping members), preferably not on the same side of the first support 101 from which the connection members 105 extend. The tether 115 can be sized such that the telescoping members 101a, 101b can expand, for example, sufficiently to align the connection members 105 with ladder rungs having a particular spacing therebetween. In some embodiments, the tether 115 can be sized, for example, to permit the connection members 105 to align with a maximum industry standard ladder rung spacing while preventing the telescoping members 101a, 101b from separating.

Continuing to refer to FIG. 1B, the first support 101, in some embodiments, can include a first longitudinal recess 108 formed therein for threaded engagement with a leveling member 107 such that the leveling member 107 can be extended or retracted relative to the first support 101 and, when the ladder leveler 10 is assembled to the ladder, relative to the bottom feet of the ladder. In order to provide such extension, the first leveling member 107 can be externally threaded for engagement with an internal thread of the longitudinal recess 108. Advantageously, the threaded engagement between the first leveling member 107 and the recess 108 can provide for continuous adjustment of an extension distance of the first leveling member 107 relative to the support, which provides a safer, more level footing for the ladder across a wider range of slope angles. Furthermore, the threaded engagement between the first leveling member 107 and the first longitudinal recess 108 provides greater load-bearing strength as compared to conventional push-button/detent configurations. In some embodiments, in order to avoid the risk of mechanical failure, the ladder leveler 10 can be designed, for example, to withstand a greater load than a rated maximum load of the ladder.

In some embodiments, the first leveling member 107 can include a leveling foot 109 engaged with a terminal end thereof. The leveling foot 109 can generally be used for stabilizing the ladder during contact with the ground or other surface(s) on which the ladder is placed, similar to ladder feet. The leveling foot 109, in some embodiments, can include a textured surface 113 in order to provide better anchoring/grip on soft surfaces as well as an attachment portion 111 configured to connect the leveling foot 109 to the leveling member 107. As shown in FIG. 1B, the attachment portion can be configured to extend over the leveling member 107 such that a pin 112 can extend through both the attachment portion 111 and the leveling member 107 to provide a hinged arrangement for maintaining contact between the leveling foot 109 and the ground or other surface during use. However, it will be apparent in view of this disclosure that any means of connecting, bonding, attaching, or otherwise engaging the leveling foot 109 to the leveling member 107 can be used in accordance with various embodiments.

The first assembly 100 can also include two or more connection members 105 sized for extension into a hollow rung of a ladder. Each connection member 105 can also generally be configured for removable engagement with the second assembly 120 as described in greater detail below. For example, as illustrated in FIG. 1B, in some embodiments, connection members 105 can include internal threads 105a to provide threaded engagement with the second assembly 120.

Referring now to FIG. 1C, the second assembly 120 can include a second support 121. As shown in FIG. 1C, in some embodiments, the second support 121 can include a first telescoping member 121a and a second telescoping member 121b for the adjustable dimensioning in connection with the assembly of the ladder leveler 10 to any size or style of ladder. In particular, similar to the telescoping members 101a, 101b of the first support 101, the telescoping members 121a, 121b of the second support 121 can permit adjustment of a distance between two or more guide members 125 extending from the second support 121 to align the guide members 125 for permitting passage of one or more insertion members 126 at least partially through respective rungs of the ladder. It will be apparent in view of this disclosure that, although the second support 121 is shown herein as including first and second telescoping members 121a, 121b, in some embodiments, the second support 121 can further include any number of additional telescoping members as desired. In some embodiments, a number of telescoping members of the second support 121 can correspond to a number of guide members 125 extending from the second support 121.

In some embodiments, to avoid inadvertent separation of the telescoping members 121a, 121b, the second assembly 120 can include at least two anchors 137 connected by a tether 135. In some embodiments, one anchor can be installed on each telescoping member (or at least on each of two telescoping members), preferably not on the same side of the second support 121 from which the guide members 125 extend. The tether 135 can be sized such that the telescoping members 121a, 121b can expand, for example, sufficiently to align the guide members 125 with ladder rungs having a particular spacing therebetween. In some embodiments, the tether 135 can be sized, for example, to permit the guide members 125 to align with a maximum industry standard ladder rung spacing while preventing the telescoping members 121a, 121b from separating.

Continuing to refer to FIG. 1C, the second support 121, in some embodiments, can include a second longitudinal recess 128 formed therein for threaded engagement with a leveling member 107 such that the leveling member 127 can be extended or retracted relative to the second support 121 and, when the ladder leveler 10 is assembled to the ladder, relative to the bottom feet of the ladder. In order to provide such extension, the second leveling member 127 can be externally threaded for engagement with an internal thread of the longitudinal recess 128. Advantageously, the threaded engagement between the second leveling member 127 and the recess 128 can provide for continuous adjustment of an extension distance of the second leveling member 127 relative to the support, which provides a safer, more level footing for the ladder across a wider range of slope angles. Furthermore, the threaded engagement between the second leveling member 127 and the second longitudinal recess 128 provides greater load-bearing strength as compared to conventional push-button/detent configurations. In some embodiments, in order to avoid the risk of mechanical failure, the ladder leveler 10 can be designed, for example, to withstand a greater load than a rated maximum load of the ladder.

In some embodiments, the second leveling member 127 can include a leveling foot 129 engaged with a terminal end thereof. The leveling foot 129 can generally be used for stabilizing the ladder during contact with the ground or other surface(s) on which the ladder is placed, similar to ladder feet. The leveling foot 129, in some embodiments, can include a textured surface 133 in order to provide better anchoring/grip on soft surfaces as well as an attachment portion 131 configured to connect the leveling foot 129 to the leveling member 127. As shown in FIG. 1B, the attachment portion can be configured to extend over the leveling member 127 such that a pin 132 can extend through both the attachment portion 131 and the leveling member 127 to provide a hinged arrangement for maintaining contact between the leveling foot 129 and the ground or other surface during use. However, it will be apparent in view of this disclosure that any means of connecting, bonding, attaching, or otherwise engaging the leveling foot 109 to the leveling member 107 can be used in accordance with various embodiments.

The second assembly 100 can also include two or more guide members 125 sized for permitting passage of an insertion member therethrough into a hollow rung of a ladder. Each guide member 125 can generally be configured to permit passage of an insertion member 126 therethrough and into a respective rung of the ladder. In some embodiments, as shown, for example, in FIG. 1C, the guide members 125 can extend outward from the second support 121 for insertion into the respective rung of the ladder. However, it will be apparent in view of this disclosure that the guide members 125 can be formed to extend from the second support 121 for any distance. It will further be apparent in view of this disclosure that, in some embodiments, the guide members 125 may be configured as a passage extending through the second support 121 only, without extending therefrom.

As noted above, the guide members 125 can generally be configured to permit passage of an insertion member 126 therethrough and into a rung of the ladder. The insertion member 126 can be any elongated member long enough to extend through the rung(s) such that the insertion member 126 can achieve engagement with the connection members 105 of the first assembly 100. In particular, as shown in FIG. 1C, the insertion members 126 include external threads 126a at a distal end, i.e. positioned opposite the second support 121 for providing threaded engagement with the internal threads 105a of the connection members 105.

The insertion member 126, as shown in FIG. 1C, in some embodiments, can be substantially similar to a bolt. However, it will be apparent in view of this disclosure that, in some embodiments, the insertion member 126 can be a member of any shape or size capable of extending through a rung of a ladder far enough to provide threaded engagement with a corresponding connection member 105. The insertion member 126 can also generally be rotatable relative to the rung and/or the guide member 125 in order to permit threading of the insertion member 126 into the corresponding connection member 105.

Although the insertion member is depicted in FIGS. 1A, 1C, 2-4, and 5B as being only partially threaded and extending through an unthreaded guide member 125, in some embodiments, the insertion member 126 can be threaded along substantially an entire length thereof In some such embodiments, the guide member 125 can also be threaded along at least a portion of its length to provide additional stability and engagement with the insertion members 126 and/or to aid in retaining the screw and reducing the risk of unthreading of the insertion member, which would result in unsafe ladder conditions.

In general, components of the ladder leveler 10 described herein, including, for example, the first support 101, the second support 121, individual telescoping members 101a, 101b, 121a, 121b, connection members 105, insertion members 126, guide members 125, leveling members 107, 127, leveling feet 109, 129, or combinations thereof can be constructed from any suitable material, including, for example, steel, aluminum, metals, alloys, carbon fiber composites, fiberglass, any other suitable materials, or combinations thereof.

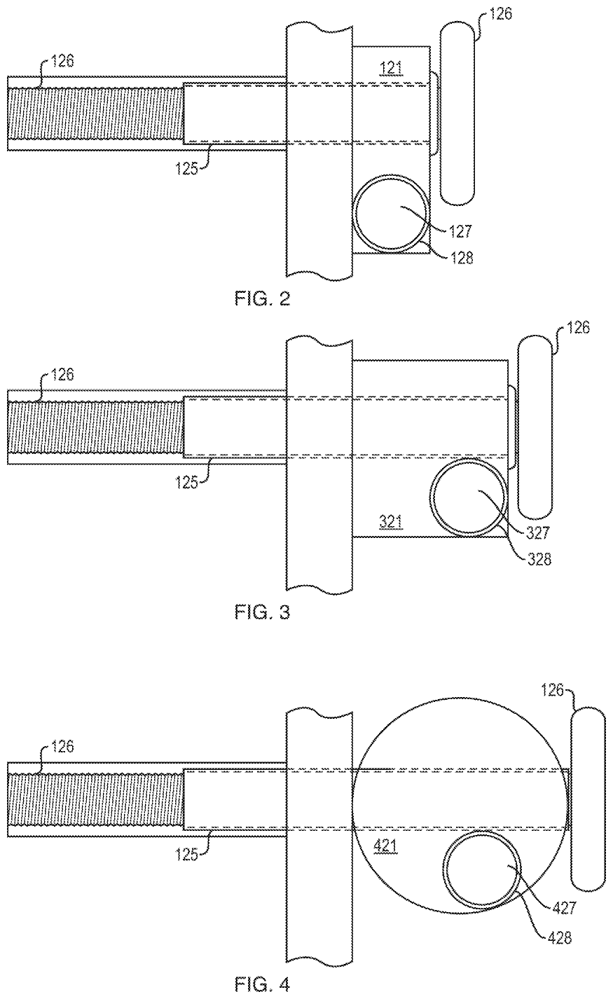

Although shown in FIG. 2 as having a rectangular cross-section for providing a stable interface with the slide rail of the ladder and accommodating both , it will be apparent in view of this disclosure that any of the first support 101, the second support 121, the individual telescoping members 101a, 101b, 121a, 121b, or combinations thereof can constructed to have any other cross-sectional shape (e.g., square, circular, elliptical, triangular, hexagonal, or any other appropriate shape) as needed for achieving a desired fit and structural strength of the ladder leveler 10/ladder assembly.

For example, as shown in FIG. 3, in some embodiments, a square second support 321 can include a substantially square cross-section. As shown, such embodiments may, for example, provide a larger geometry to provide increased load bearing strength and greater spacing between a longitudinal recess 328 and the ladder rail. The increased spacing between the longitudinal recess 328 and the ladder rail also, therefore, provides increased spacing between an extension member 327 and the ladder rail. Such increased spacing can facilitate, for example, the use of larger extension feet to provide greater stability for the leveled ladder without creating interference between the extension feet and the ladder feet.

Also for example, as shown in FIG. 4, in some embodiments, a round second support 421 can include a substantially round cross-section. As shown, such embodiments may, for example, provide a larger geometry to provide increased load bearing strength, reduce production costs, and/or eliminate sharp edges. In some embodiments, the round second support 421 can be offset from center relative to the rail in order to avoid interference between the guide member 125 and the longitudinal recess 428 into which an extension member 427 is threaded.

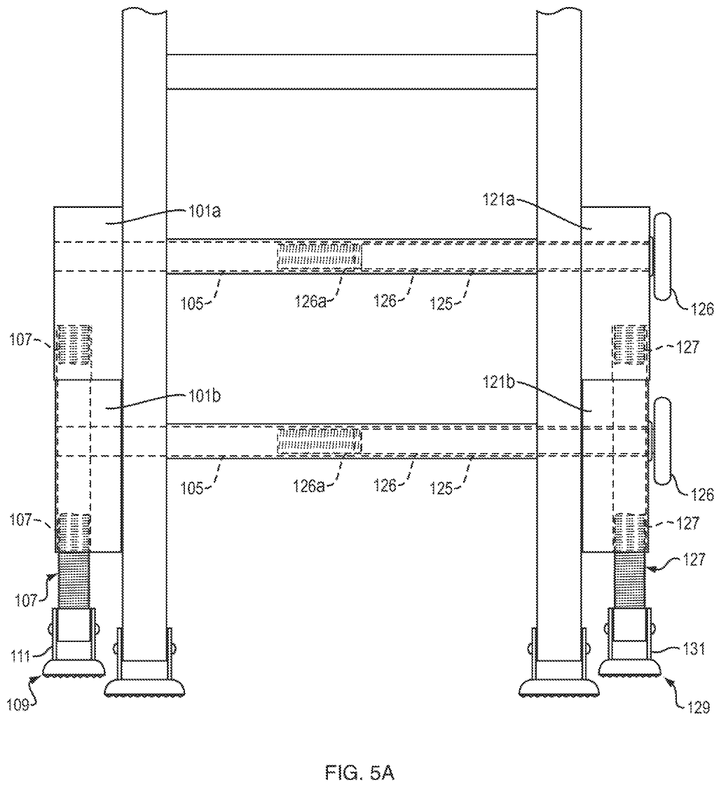

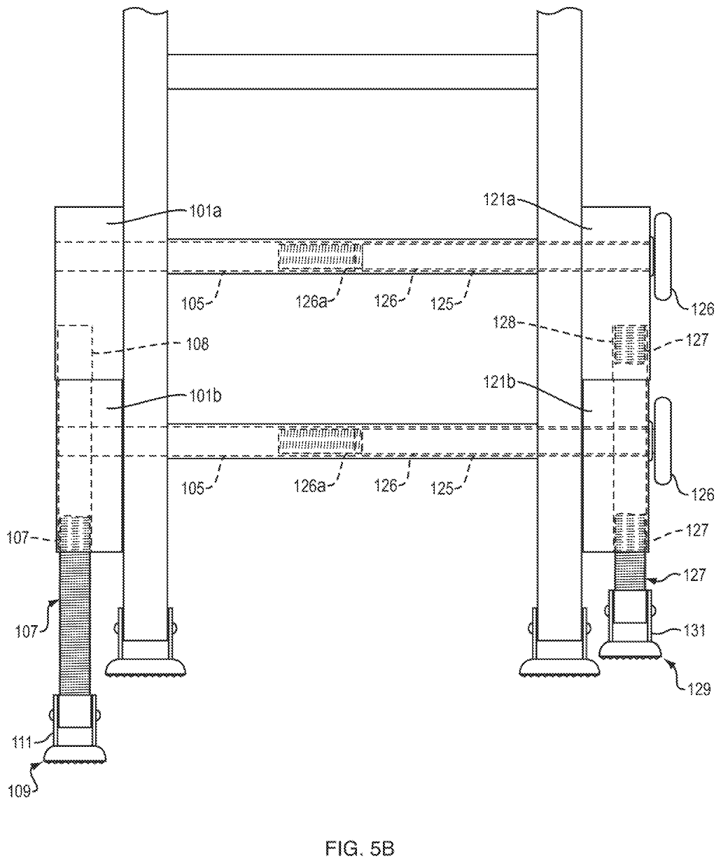

FIGS. 5A-5B illustrate the ladder leveler 10 assembled to a ladder. As illustrated in both FIG. 5A and FIG. 5B, each of the insertion members 126 and corresponding connection members 105 are configured such that each insertion member 126/connection member 105 pair has a sufficient combined length to achieve threaded engagement within the rung. Furthermore, each insertion member 126/connection member 105 pair can have a combined length short enough to permit the threaded engagement of the insertion member 126/connection member 105 pair to secure the supports 101, 121 against the respective slide rail to which they are adjacent. Advantageously, a length of the threaded portions 105a, 126a of the connection member 105 and the insertion member 126 can be sufficient to permit assembly of the ladder leveler 10 to ladders of any width. For example, ladders can generally be of a width between about 12″ to about 24″ from an outer surface of the first slide rail to an outer surface of the second slide rail with many being between about 16″ to about 18″. However, it will be apparent in view of this disclosure that, in accordance with various embodiments, insertion member 126/connection member 105 pairs can include any combined threaded length for accommodating any ladder width.

In FIG. 5A, both leveling members 107, 127 are retracted such that leveling feet 109, 129 are positioned above the corresponding ladder feet. Such a configuration is typically suitable for ladder use on flat ground but, as noted above, would result in ladder instability and/or falling if placed on a sloped, stepped, or otherwise uneven surface. In contrast, FIG. 5B illustrates the ladder leveler 10 wherein the first leveling member 107 has been extended beyond the bottom of the ladder feet. As shown in FIG. 5B, the second leveling member 127 remains retracted. Thus, due to the difference in extension distance between the first and second leveling members 107, 127, the ladder leveler 10 can be used on a sloped, stepped, or uneven surface. In use, to the extent that the ladder was placed on a, for example, step of a staircase, and the first leveling member 107 was extended slightly too far, the user would simply need to twist the first leveling member 107 to retract it until the proper position is achieved. Advantageously, because the threaded portion is continuously adjustable, the ladder leveler 10 can always provide a straight, stable platform for the ladder, regardless of slope, step size, terrain, etc.

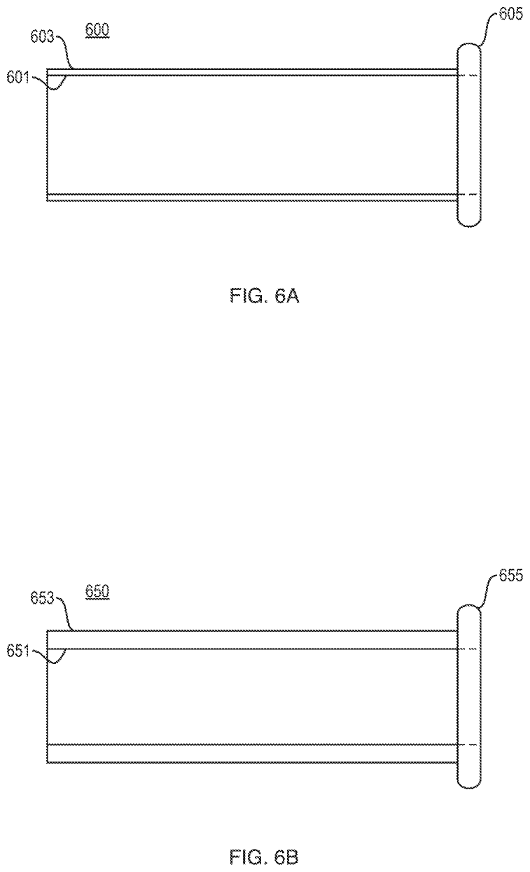

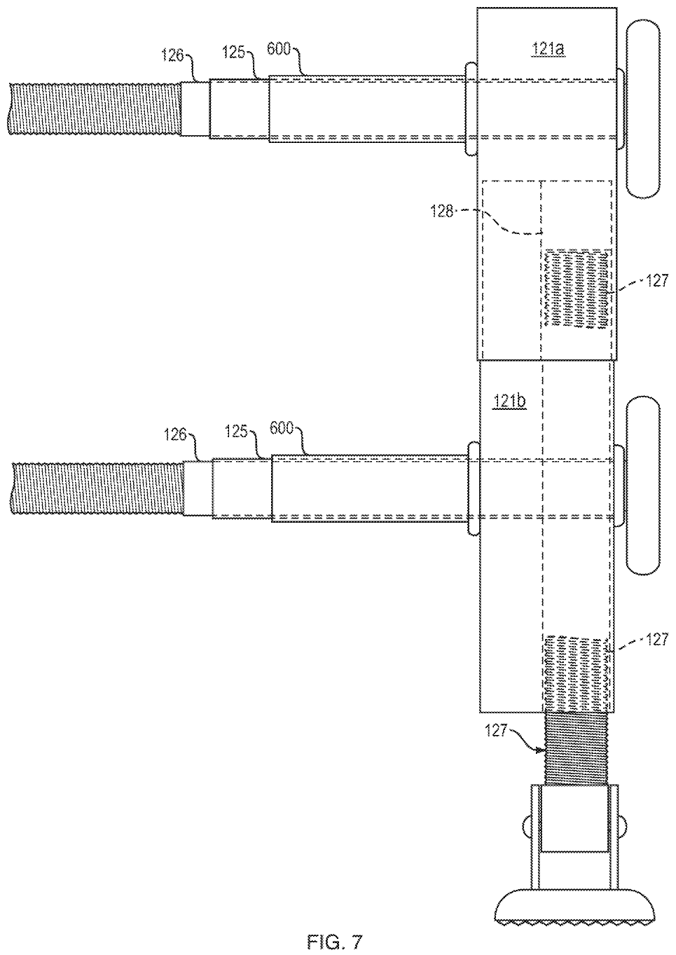

Referring now to FIGS. 6A, 6B, and 7, in some embodiments, spacers 600, 650 of varying wall thickness can be provided to aid in achieving a proper fit between the connection members 105, the insertion members 126, and/or the guide members 125 to the ladder rungs. In particular, ladders having hollow rungs come in a wide variety of diameter sizes and shapes. For example, ladders commonly include either round rungs or D-shaped rungs. However, in accordance with various embodiments, the ladder leveler 10 of this disclosure can be used in connection with any rung shape (e.g., round, D-shaped, square, rectangular, hexagonal, or any other suitable shape). Furthermore, ladder rungs can be a variety of sizes. For example, ladder rungs may commonly have an internal diameter or height of about 1″ to about 1.5″. However, depending on size, load rating, material, and design choices associated with the ladder, rungs of any size may be used.

Therefore, in order for the ladder leveler 10 to safely be assembled to all or most ladders, the diameter and size of the connection members 105, the insertion members 126, and the guide members 125 must be small enough to be inserted into the smallest known rungs. However, in order to avoid instability and unwanted motion of the ladder leveler 10 relative to the ladder, clearance should be minimized between the interior of the ladder rungs and the exterior of the connection members 105, the insertion members 126, and the guide members 125, wherein a flush fit is preferable but a small clearance (e.g., radial clearances of 0.1 mil to 100 mil, 0.1 mil to 10 mil, 0.1 mil to 5 mil, or any other clearance suitable for avoiding significant instability or motion of the ladder relative to the ladder leveler 10) may be acceptable.

To the extent that the ladder in use includes rungs larger than the smallest compatible size, sets of spacers 600, 650 of varying wall thickness can be provided to a user for installation over the connection members 105, the insertion members 126, and/or the guide members 125. As shown in FIGS. 6A-6B, each spacer 600, 650 can generally be an elongated cylinder having an inner diameter 601, 651 and an outer diameter 603, 653. In some embodiments, the spacer 600, 650 can also include a flange 605, 655 for abutting the first or second support 100, 120 when the spacer is installed.

The inner diameter 601, 651 of each spacer 600, 650 in each set of spacers 600, 650 can be, for example, sized for a flush fit or small clearance fit with the outer diameters of the connection members 105 and the outer diameters of the insertion members 126 and/or the guide members 125. In this manner, each set of spacers 600, 650 is configured for interchangeable engagement with the ladder leveler 10 as needed for assembling the ladder leveler 10 to one or more ladders having different sized rungs.

Each “set” of spacers 600, 650 can generally include a plurality of spacers 600, 650 having a same outer diameter 603, 653, wherein the number of spacers 600, 650 in the set is equivalent to the total number of connection members 105 and insertion members 126 and/or guide members 125 requiring spacing for proper fit. In accordance with various embodiments, any number of sets of spacers 600, 650 can be provided for interchangeable use with the ladder leveler 10. In this manner, the ladder leveler 10 is capable of providing proper fit with any number of ladder rung sizes. The outer diameters 603, 653 of each set of spacers 600, 650 can generally be the same, with each set providing a different outer diameter 603, 653 size to fit with a different ladder rung size. Generally, the number of sets of spacers 600, 650 can be sufficient to provide proper fit to any known ladder rung size (or as many ladder rung sizes as commercially desired). Thus, in some embodiments, spacer sets 600, 650 can be provided, for example, for ladder rung sizes ranging from about 1″ to about 2″ at, for example, 0.125″ increments, 0.25″ increments, or at a plurality of specific sizes associated with known ladder rung sizes.

As shown in FIG. 7, installation of the spacers 600, 650 can be achieved by sliding the spacers 600, 650 over the connection members 105, the insertion members 126, and/or the guide members 125 such that the flange 605, 655 abuts the first or second support 100, 120. When a spacer having the correct thickness is installed, the inner diameter 601, 651 will form a flush or low-clearance fit between the connection members 105, the insertion members 126, and/or the guide members 125. Furthermore, a correctly sized spacer 600, 650 will form a flush or low-clearance fit between the outer diameter 603, 653 and the ladder rung. Thus, the spacers permit an adjustable fit to prevent ladder instability while preserving the utility and adaptability of the ladder leveler 10 assembly with respect to ladder size and brand.

While the foregoing description of the invention enables one of ordinary skill to make and use what is considered presently to be the best mode thereof, those of ordinary skill will understand and appreciate the existence of variations, combinations, and equivalents of the specific embodiments and examples herein. The above-described embodiments of the present invention are intended to be examples only. Alterations, modifications and variations may be effected to the particular embodiments by those of skill in the art without departing from the scope of the invention, which is defined solely by the claims appended hereto. The invention is therefore not limited by the above described embodiments and examples.

Having described the invention, and a preferred embodiment thereof, what is claimed as new and secured by Letters Patent is:

1. A ladder leveler, comprising:
a first assembly including:
a first support having a first longitudinal recess formed therein,
a first leveling member in threaded engagement with the first longitudinal recess for extension and retraction relative to the first support,
a first connection member extending substantially perpendicular to the first support, and
a second connection member extending substantially perpendicular to the first support and substantially parallel to the first connection member; and
a second assembly including:
a second support having a second longitudinal recess formed therein,
a second leveling member in threaded engagement with the second longitudinal recess for extension and retraction relative to the second support,
a first insertion member extending substantially perpendicular to the second support and configured for threaded engagement with the first connection member, and
a second insertion member extending substantially perpendicular to the second support and substantially parallel to the first insertion member, the second insertion member configured for threaded engagement with the second connection member,
wherein the connection members and the insertion members are sized for extension through and threaded engagement within ladder rungs of a ladder.

2. The ladder leveler of claim 1, wherein:
the first support including two or more first telescoping members; and
the second support including two or more second telescoping members.

3. The ladder leveler of claim 2, wherein:
the first and second connection members extend from different first telescoping members to permit adjustment of spacing therebetween for alignment of the first and second connection members with the ladder rungs, and
the first and second insertion members extend from different second telescoping members to permit adjustment of spacing therebetween for alignment of the first and second insertion members with the ladder rungs.

4. The ladder leveler of claim 2, further comprising:
a first anchor affixed to each of the first telescoping members of the first support;
a first tether connecting the first anchors for preventing separation of the first telescoping members;
a second anchor affixed to each of the second telescoping members of the second support; and
a second tether connecting the second anchors for preventing separation of the second telescoping members.

5. The ladder leveler of claim 1, further comprising:
a first leveling foot engaged with a terminal end of the first leveling member; and
a second leveling foot engaged with a terminal end of the second leveling member.

6. The ladder leveler of claim 1, further comprising
a first guide member extending substantially perpendicular to the second support and configured to receive the first insertion member therethrough, and
a second guide member extending substantially perpendicular to the second support and substantially parallel to the first guide member, the second guide member configured to receive the second insertion member therethrough. A method for assembling a ladder leveler comprising:
aligning a first connection member of a ladder leveler with a hollow end of a first rung of a ladder;
aligning a second connection member of the ladder leveler with a hollow end of a second rung of the ladder;
inserting the first and second connection members into the aligned first and second rungs of the ladder;
aligning a first insertion member of the ladder leveler with an opposing hollow end of the first rung;
aligning a second insertion member of the ladder leveler with an opposing hollow end of the second rung;
inserting the first and second insertion members into the aligned first and second rungs of the ladder;
engaging the first connection member to the first insertion member and the second connection member to the second connection member to secure the ladder leveler to the ladder.

8. The method of claim 7, wherein the first and second connection members each extend perpendicular to one of two or more telescoping members of a first support of the ladder leveler, the steps of aligning the first and second connection members further comprising moving at least one of the telescoping members relative to at least one other of the telescoping members to adjust a spacing between the first and second connection members for alignment of the first and second connection members with the hollow ends of the first and second rungs.

9. The method of claim 8, wherein the first support further comprises:
an anchor affixed to each of the telescoping members of the first support;
a tether connecting the anchors for preventing separation of the telescoping members.

10. The method of claim 7, wherein the first and second insertion members each extend perpendicular to one of two or more telescoping members of a second support of the ladder leveler, the steps of aligning the first and second insertion members further comprising moving at least one of the telescoping members relative to at least one other of the telescoping members to adjust a spacing between the first and second insertion members for alignment of the first and second insertion members with the opposing hollow ends of the first and second rungs.

11. The method of claim 10, wherein the second support further comprises:
an anchor affixed to each of the telescoping members of the second support;
a tether connecting the anchors for preventing separation of the telescoping members.

12. A method for using a ladder leveler, comprising:
providing a ladder leveler assembled to a ladder, the ladder leveler including:
a first assembly having:
a first support having a first longitudinal recess formed therein,
a first leveling member in threaded engagement with the first longitudinal recess, and
a second assembly including:
a second support having a second longitudinal recess formed therein,
a second leveling member in threaded engagement with the second longitudinal recess; and
threading or unthreading at least one of the first leveling member or the second leveling member such that the first leveling member extends from the first support by a different distance than the second leveling member extends from the second support.

13. The method of claim 12, further comprising:
placing a terminal end of the first leveling member on a first portion of a surface, the surface being at least one of uneven, sloped, or stepped; and
placing a terminal end of the second leveling member on a second portion of the surface, the second portion of the surface having a different height than the first portion of the surface.

14. The method of claim 13, wherein placement of the terminal ends of the first and second leveling members on the respective first and second portions of the surface causes each of a plurality of rungs of the ladder to extend substantially horizontally without sloping.

15. The method of claim 12, the ladder leveler further comprising:
a first leveling foot engaged with a terminal end of the first leveling member; and
a second leveling foot engaged with a terminal end of the second leveling member.

16. The method of claim 14, further comprising:
placing the first leveling foot on a first portion of a surface, the surface being at least one of uneven, sloped, or stepped; and
placing the second leveling foot on a second portion of the surface, the second portion of the surface having a different height than the first portion of the surface.

17. The method of claim 16, wherein placement of the first and second leveling feet on the respective first and second portions of the surface causes each of a plurality of rungs of the ladder to extend substantially horizontally without sloping.
